(19) United States
(12) Patent Application Publication
(10) Pub. No.: US 2022/0121916 A1
(43) Pub. Date: Apr. 21, 2022

(54) ELECTRONIC DEVICE AND OPERATING METHOD THEREOF

(71) Applicant: SAMSUNG ELECTRONICS CO., LTD., Suwon-si (KR)

(72) Inventors: Sunwoong JOO, Suwon-si (KR); Jongin LEE, Suwon-si (KR)

(73) Assignee: SAMSUNG ELECTRONICS CO., LTD., Suwon-si (KR)

(21) Appl. No.: 17/507,411

(22) Filed: Oct. 21, 2021

Related U.S. Application Data
(63) Continuation of application No. PCT/KR2021/012751, filed on Sep. 17, 2021.

(30) Foreign Application Priority Data
Oct. 21, 2020 (KR) 10-2020-0137087

(51) Int. Cl. G06N 3/063; G06N 3/04; G06F 11/34

(52) U.S. Cl. CPC G06N 3/063; G06F 11/3419; G06N 3/04

(57) ABSTRACT

An electronic device for performing inference by using a neural network, including a memory configured to store one or more instructions and information about the neural network, wherein the neural network may include a common block and a selectable block set; and a processor including a plurality of accelerators, and configured to execute the one or more instructions to: obtain inference time information about the neural network for each of the plurality of accelerators, based on the information about the neural network; determine an accelerator for performing the inference according to the neural network from among the plurality of accelerators, based on the inference time information about the neural network; select a candidate block corresponding to the accelerator from among a plurality of candidate blocks included in the selectable block set; and perform the inference according to the neural network using the common block and the candidate block.

### CROSS-REFERENCE TO RELATED APPLICATIONS

This application is a Continuation Application of International Application PCT/KR2021/012751 filed on Sep. 17, 2021, which claims priority from Korean Patent Application No. 10-2020-0137087 filed on Oct. 21, 2020, in the Korean Intellectual Property Office, the disclosures of which are incorporated by reference herein in their entireties.

### TECHNICAL FIELD

The disclosure relates to an electronic device and an operating method thereof, and more particularly, to an electronic device for performing inference of a neural network and an operating method of the electronic device.

### BACKGROUND ART

Recent research using artificial neural networks has expanded from improvement of inference accuracy of images, videos, or natural language based tasks to neural network optimization and automatic structuring.

An optimized structure of a neural network for improving inference efficiency may vary according to a type of an accelerator used for inference of the neural network. Accordingly, structures of neural networks efficiently operating in a central processing unit (CPU) and a graphics processing unit (GPU) may be different from each other. Accordingly, when a target device includes a plurality of accelerators, a neural network providing apparatus may distribute optimized neural networks for the respective accelerators in order to improve the efficiency of neural network inference.

Also, when an accelerator is dynamically switched during inference, the optimized neural network for the accelerator may be switched, thereby increasing a required time and memory usage.

### DESCRIPTION OF EMBODIMENTS

### Technical Problem

Provided are an electronic device including a plurality of accelerators and capable of providing an optimal neural network according to an accelerator for performing inference of a neural network, and an operating method of the electronic device.

### Technical Solution to Problem

In accordance with an aspect of the disclosure, an electronic device for performing inference by using a neural network includes a memory configured to store one or more instructions and information about the neural network, wherein the neural network may include a common block and a selectable block set; and a processor including a plurality of accelerators, and configured to execute the one or more instructions to: obtain inference time information about the neural network for each of the plurality of accelerators, based on the information about the neural network; determine an accelerator for performing the inference according to the neural network from among the plurality of accelerators, based on the inference time information about the neural network; select a candidate block corresponding to the accelerator from among a plurality of candidate blocks included in the selectable block set; and perform the inference according to the neural network using the common block and the candidate block.

The information about the neural network may include a structure of the neural network and at least one weight of the neural network, and the electronic device may further include a communication interface configured to receive a neural network model the including the information about the neural network from an external device.

The neural network may be trained so that a difference between operation results output using the plurality of candidate blocks included in the selectable block set is less than a preset value.

The plurality of accelerators may include at least one from among a central processing unit (CPU), a graphics processing unit (GPU), a neural processing unit (NPU), and a digital signal processor (DSP).

The information about the neural network may include information indicating the candidate block corresponding to the accelerator from among the plurality of candidate blocks according to a type of the accelerator, and the processor may be further configured to obtain an inference time associated with the neural network using the each of the plurality of accelerators, based on the information indicating the candidate block.

The inference time information about the neural network may include inference time information about each of the plurality of candidate blocks, using the each of the plurality of accelerators.

The processor may be further configured to execute the one or more instructions to determine an accelerator having a shortest inference time of the neural network from among the plurality of accelerators as the accelerator.

The processor may be further configured to execute the one or more instructions to store the inference time information about the neural network for the each of the plurality of accelerators in the memory.

The processor may be further configured to execute the one or more instructions to select a candidate block having a shortest inference time corresponding to the accelerator, from among the plurality of candidate blocks included in the selectable block set, as the candidate block.

The processor may be further configured to execute the one or more instructions to control a flow of the neural network, so that output data of a block prior to the candidate block is provided as input to the candidate block.

In accordance with an aspect of the disclosure, an operating method of an electronic device including a plurality of accelerators and capable of performing inference by using a neural network includes obtaining inference time information of the neural network for each of the plurality of accelerators, based on information about the neural network, wherein the neural network may include a common block and a selectable block set; determining an accelerator for performing the inference according to the neural network from among the plurality of accelerators, based on the inference time information about the neural network; selecting a candidate block corresponding to the accelerator from among a plurality of candidate blocks included in the selectable block set; and performing the inference according to the neural network using the common block and the candidate block.

The information about the neural network may include a structure of the neural network and at least one weight of the neural network, and wherein the operating method may further include receiving a neural network model file including the information about the neural network from an external device.

The neural network may be trained so that a difference between operation results output using the plurality of candidate blocks included in the selectable block set is less than a preset value.

The plurality of accelerators may include at least one from among a central processing unit (CPU), a graphics processing unit (GPU), a neural processing unit (NPU), and a digital signal processor (DSP).

The information about the neural network may include information indicating the candidate block corresponding to the accelerator from among the plurality of candidate blocks according to a type of the accelerator, and the obtaining of the inference time information may include obtaining an inference time associated with the neural network using the each of the plurality of accelerators, based on the information indicating the candidate block.

The obtaining of the inference time information may include obtaining inference time information about each of the plurality of candidate blocks, using the each of the plurality of accelerators.

The determining of the accelerator may include determining an accelerator having a shortest inference time of the neural network from among the plurality of accelerators as the accelerator.

The operating method may further include storing the inference time information about the neural network for the each of the plurality of accelerators in the memory.

The selecting of the candidate block may include selecting a candidate block having a shortest inference time corresponding to the accelerator, from among the plurality of candidate blocks included in the selectable block set, as the candidate block.

The performing of the inference of the neural network may include controlling a flow of the neural network, so that output data of a block prior to the candidate block is provided as input to the candidate block.

In accordance with an aspect of the disclosure, a non-transitory computer-readable recording medium having stored thereon instructions which, when executed by at least one processor of a device including a plurality of accelerators and capable of performing inference by using a neural network, cause the at least one processor to: obtain inference time information of the neural network for each of the plurality of accelerators, based on information about the neural network, wherein the neural network includes a common block and a selectable block set; determine an accelerator for performing the inference according to the neural network from among the plurality of accelerators, based on the inference time information about the neural network; select a candidate block corresponding to the accelerator from among a plurality of candidate blocks included in the selectable block set; and perform the inference according to the neural network using the common block and the candidate block.

### BRIEF DESCRIPTION OF DRAWINGS

FIG. 1 is a diagram illustrating a neural network providing apparatus and a target device, according to an embodiment.

FIG. 2 is a diagram illustrating different structures of neural networks for performing data processing according to preset purposes, according to an embodiment.

FIG. 3 is a diagram illustrating a neural network, according to an embodiment.

FIG. 4 is a block diagram illustrating a configuration of a target device, according to an embodiment.

FIG. 5 is a diagram illustrating neural networks configurable according to candidate blocks selected in the neural network of FIG. 3, according to an embodiment.

FIG. 6 is a diagram illustrating an example of controlling a flow of a neural network by using a flow control operator, according to an embodiment.

FIG. 7 is a flowchart illustrating an operating method of an electronic device, according to an embodiment.

FIG. 8 is a block diagram illustrating a configuration of an electronic device, according to an embodiment.

### MODE OF DISCLOSURE

Throughout the disclosure, the expression “at least one of a, b or c” indicates only a, only b, only c, both a and b, both a and c, both b and c, all of a, b, and c, or variations thereof.

Various terms used herein will be briefly described, and the disclosure will be described in detail.

Terms used herein may be general terms currently widely used in consideration of functions in the disclosure but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein should be defined based on the unique meanings thereof and the whole context of the disclosure.

It will be understood that when a certain part “includes” a certain component, the part does not exclude another component but may further include another component, unless the context clearly dictates otherwise. Also, the term such as “unit” or “module” used herein may refer to a unit that performs at least one function or operation, and the unit may be implemented as hardware or software or as a combination of hardware and software.

The term “user” used herein may refer to a viewer who watches an image displayed in an electronic device or a person who controls a function or an operation of the electronic device, and may include a manager or an installation engineer.

The disclosure will now be described more fully with reference to the accompanying drawings for one of ordinary skill in the relevant art to be able to perform the disclosure without any difficulty. However, the disclosure may be embodied in many different forms and is not limited to the embodiments of the disclosure set forth herein. For clarity, portions irrelevant to the descriptions of the disclosure are omitted in the drawings, and like components are denoted by like reference numerals throughout the specification.

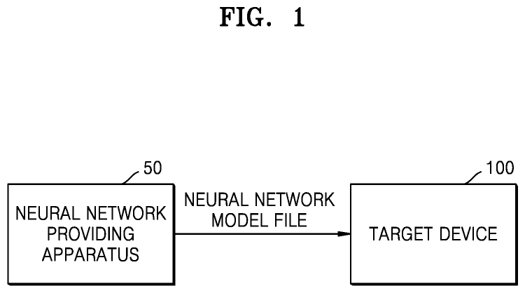

FIG. 1 is a diagram illustrating a neural network providing apparatus and a target device, according to an embodiment of the disclosure.

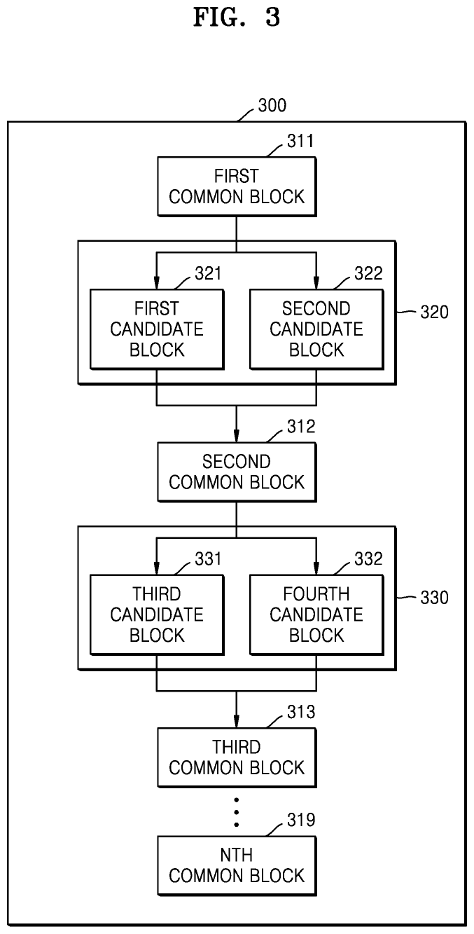

Referring to FIG. 1, a neural network providing apparatus 50 may train a neural network for processing data according to preset purposes. For example, the neural network providing apparatus 50 may determine a structure of the neural network for processing data according to the preset purposes, and may determine weights included in the neural network by training the neural network having the determined structure. The term ‘neural network’ according to an embodiment of the disclosure may be a network including a structure of a neural network and weights included in the neural network, for example neural network weights. The neural network weights that are the strength of connection of the neural network may be targets updated by training. An example of a training method, performed by the neural network providing apparatus 50, of determining the neural network weights will be described below with reference to FIG. 3.

The neural network providing apparatus 50 may distribute information about the trained neural network to the target device 100. For example, the neural network providing apparatus 50 may distribute the trained neural network as a data file, for example a neural network model file, including the structure of the neural network and the neural network weights, or may distribute the trained neural network as a neural network compiler including code optimized for the neural network. However, the disclosure is not limited thereto.

The target device 100 according to an embodiment of the disclosure may be any of various electronic devices such as a TV, a mobile phone, a tablet PC, a digital camera, a camcorder, a laptop computer, a desktop, an e-book terminal, a digital broadcasting terminal, a personal digital assistant (PDA), a portable multimedia player (PMP), a navigation device, an MP3 player, or a wearable device. The target device 100 may receive the information about the neural network, for example the neural network model file, from the neural network providing apparatus 50.

Also, the target device 100 according to an embodiment of the disclosure may include a plurality of accelerators for performing neural network inference. In this case, the plurality of accelerators may include at least one of a central processing unit (CPU), a graphics processing unit (GPU), a neural processing unit (NPU), or a digital signal processor (DSP), but embodiments are not limited thereto.

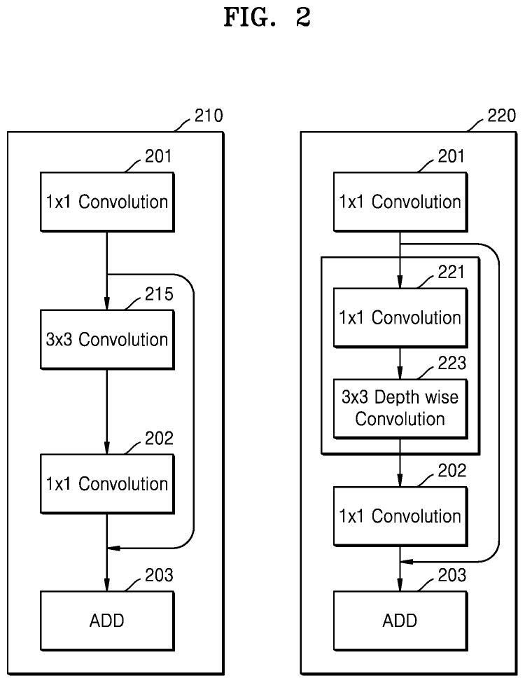

The target device 100 according to an embodiment of the disclosure may perform neural network inference by using any one of the plurality of accelerators, in order to process data according to preset purposes. In this case, a structure of a neural network for optimizing an inference time may vary according to a type of an accelerator that performs inference, an example of which will be described below in detail with reference to FIG. 2.

FIG. 2 is a diagram illustrating different structures of neural networks for performing data processing according to preset purposes.

A first neural network 210 of FIG. 2 and a second neural network 220 of FIG. 2 may be neural networks for performing data processing according to the same purpose. For example, the first neural network 210 and the second neural network 220 are neural networks for performing the same function, and may output the same or similar result data when the same data is input to the first neural network 210 and the second neural network 220.

The second neural network 220 may be a neural network obtained by replacing a 3×3 convolution layer 215 included in the first neural network 210 with a combination of a 1×1 convolution layer 221 and a 3×3 depthwise convolution layer 223. For example, because the number of weights, or for example parameters, and the amount of computation when a 1×1 convolution operation and a 3×3 depthwise convolution operation are performed may be less than those when a 3×3 convolution operation is performed, the second neural network 220 may be lighter than the first neural network 210.

Accordingly, when inference of the second neural network 220 is performed by using a CPU, the amount of computation and an inference time may be reduced, as compared to when inference of the first neural network 210 is performed. On the other hand, when inference of the second neural network 220 is performed by using a GPU or an NPU, a processor may not be sufficiently utilized due to the structural characteristics of the GPU or the NPU. Accordingly, when inference of the first neural network 210 is performed by using the GPU or the NPU, the number of weights included in a neural network and the amount of computation may be increased but an inference time may be reduced, compared to when inference of the second neural network 220 is performed.

As such, a structure of a neural network suitable for an accelerator may vary according to a type, performance, a structure, the number of cores, and memory specifications of the accelerator.

Accordingly, when a target device includes a plurality of different types of accelerators, a neural network suitable for inference, for example a structure and weights of a neural network, may vary according to an accelerator that performs neural network inference, and in order to perform optimal inference, the target device should receive neural networks individually optimized for the plurality of accelerators from the neural network providing apparatus 50. However, it is inefficient in terms of memory usage to receive and store all of the neural networks individually optimized for the plurality of accelerators.

In order to solve such problems, a neural network according to an embodiment of the disclosure provided from the neural network providing apparatus 50 may include a common block and a selectable block set to provide an optimized neural network according to an accelerator. An example of a neural network according to an embodiment of the disclosure will be described in detail with reference to FIG. 3.

FIG. 3 is a diagram illustrating a neural network, according to an embodiment of the disclosure.

A neural network 300 according to an embodiment of the disclosure may include common blocks and selectable block sets. The term ‘common block’ may refer to a block including operations that may be commonly included in order for the neural network 300 to process data according to preset purposes regardless of a type of an accelerator that performs neural network inference. For example, layer 201 included in the first neural network 210 may be the same as layer 201 included in the second neural network 220. Similarly, layer 202 included in the first neural network 210 may be the same as layer 202 included in the second neural network 220. In addition, layer 203 included in the first neural network 210 may be the same as layer 203 included in the second neural network 220. Accordingly, the layers 201 and 202 that perform a 1×1 convolution operation and the layer 203 that performs an addition operation ADD may be configured as common blocks.

Also, a selectable block set according to an embodiment of the disclosure may include a plurality of candidate blocks, and any one of the plurality of candidate blocks is selected. The plurality of candidate blocks according to an embodiment of the disclosure may perform the same function but may have different structures. For example, the numbers of layers included in the plurality of candidate blocks, types of operations performed in the layers, etc. may be different from one another. Also, the plurality of candidate blocks may be trained so that operation results output from the plurality of candidate blocks are the same or similar to one another, and a difference between the operation results output from the plurality of candidate blocks may be within a preset range.

For example, a 3×3 convolution operation included in the first neural network 210 of FIG. 2 may be the same as or similar to a combination of a 1×1 convolution operation and a 3×3 depthwise convolution operation included in the second neural network 220. Accordingly, the 3×3 convolution layer 215 may be configured as one candidate block included in a selectable block set, and the combination of the 1×1 convolution layer 221 and the 3×3 depthwise convolution layer 223 may be configured as another candidate block included in the selectable block set.

Referring to FIG. 3, the neural network 300 according to an embodiment of the disclosure may include first common block 311, second common block 312, third common block 313, . . . , and n^{th} common block 319, and may include a first selectable block set 320 and a second selectable block set 330. However, the neural network 300 of FIG. 3 is merely an example, and may be configured in any of various ways.

For example, when the first neural network 210 and the second neural network 220 of FIG. 2 are applied to the neural network 300 of FIG. 3, the 1×1 convolution layer 201 commonly included in the first neural network 210 and the second neural network 220 may be configured as the first common block 311, a combination of the 3×3 convolution layer 215 and the 1×1 convolution layer 202 of the first neural network may be configured as a first candidate block 321 included in the first selectable block set 320, a combination of the 1×1 convolution layer 221, the 3×3 depthwise convolution layer 223, and the 1×1 convolution layer 202 of the second neural network 220 may be configured as a second candidate block 322 included in the first selectable block set 320, and the layer 203 commonly included in the first neural network and the second neural network may be configured as a second common block 312.

In embodiments, the 1×1 convolution layer 202 of the first neural network 210 and the 1×1 convolution layer 202 of the second neural network 220 may not be respectively included in the first candidate block 321 and the second candidate block 322, but may be configured as a separate common block. However, the disclosure is not limited thereto.

When a structure of a neural network is determined as shown in FIG. 3, the neural network providing apparatus 50 according to an embodiment may determine weights included in the neural network by using training.

The neural network providing apparatus 50 according to an embodiment of the disclosure may first select an arbitrary candidate block in each of selectable block sets included in a neural network, and then may train a neural network including common blocks and the selected arbitrary candidate blocks. Accordingly, the neural network providing apparatus 50 may determine weights included in the common blocks and the arbitrary candidate blocks. For example, the neural network providing apparatus 50 may select the first candidate block 321 in the first selectable block set 320, may select a third candidate block 331 in the second selectable block set 330, and may train a neural network including the first common block 311, the first candidate block 321, the second common block 312, the third candidate block 331, and the third through n^{th} common blocks 313, . . . , and 319, to determine weights included in the first common block 311, the first candidate block 321, the second common block 312, the third candidate block 331, and the third through n^{th} common blocks 313, . . . , and 319.

The neural network providing apparatus 50 may fix the determined weights included in the first through n^{th} common blocks, and may train weights included in remaining candidate blocks. For example, the neural network providing apparatus 50 may select the second candidate block 322 in the first selectable block set 320, may select a fourth candidate block 332 in the second selectable block set 330, and may train a neural network including the first common block 311, the second candidate block 322, the second common block 312, the fourth candidate block 332, and the third through n^{th} common blocks 313, . . . , and 319. In this case, values of weights included in first through n^{th} common blocks may not be updated, and weights included in the second candidate block 322 and the fourth candidate block 332 may be additionally determined.

Even when a neural network is configured by selecting a candidate block in a selectable block set by using the above-described training method, neural networks may be trained so that final output data of the neural networks are similar, and a difference between values output from candidate blocks may be within a preset range. Accordingly, even when a candidate block is selected in a selectable block set, the neural network providing apparatus 50 may train neural networks so that the performance and accuracy of the neural networks are similar.

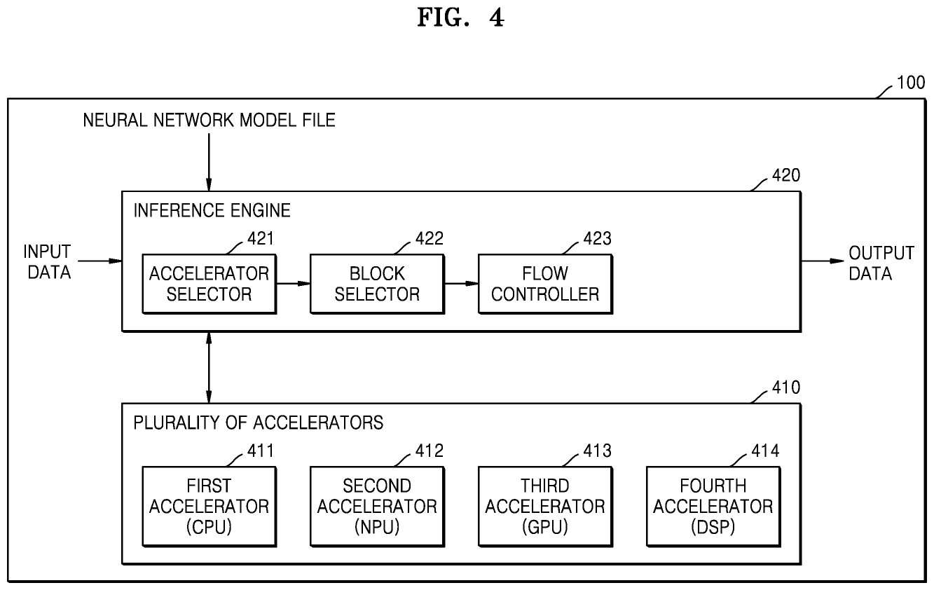

FIG. 4 is a block diagram illustrating a configuration of a target device, according to an embodiment of the disclosure.

Referring to FIG. 4, the target device 100 according to an embodiment of the disclosure may include a plurality of accelerators 410 and an inference engine 420.

The target device 100 according to an embodiment of the disclosure may include the plurality of accelerators 410, and there may be a plurality of accelerators available during neural network inference. The plurality of accelerators 410 may include first accelerator 411, second accelerator 412, third accelerator 413, and fourth accelerator 414, and each of the first through fourth accelerators may be one of, but not limited to, a central processing unit (CPU), a graphics processing unit (GPU), a neural processing unit (NPU), and a digital signal processor (DSP).

The target device 100 according to an embodiment of the disclosure may receive information about a trained neural network from the neural network providing apparatus 50. The information about the trained neural network may be distributed as a data file, for example a neural network model file, including a neural network structure and neural network weights to the target device 100. For example, the neural network providing apparatus 50 may generate the neural network model file for executing the trained neural network in the target device 100 by using a TensorFlow program, and may distribute the generated neural network model file to the target device 100. The TensorFlow program may refer to software that implements a function, for example an operator, for performing a function of each of a plurality of layers included in a neural network.

When the target device 100 receives the neural network model file including the information about the neural network, the target device 100 may store the received neural network model file in a memory. In this case, the memory in which the neural network model file is stored may be an auxiliary storage device of the target device 100.

The inference engine 420 according to an embodiment of the disclosure may be an element for performing neural network inference, and may generate output data by executing the neural network model file and processing input data. The inference engine 420 according to an embodiment of the disclosure may perform repetitive data processing by using a neural network. For example, the inference engine 420 may process a video, an audio, or streaming data including a plurality of frame images, by performing repetitive neural network inference. However, the disclosure is not limited thereto.

The inference engine 420 may include an accelerator selector 421, a block selector 422, and a flow controller 423. The accelerator selector 421 may determine an optimal accelerator for performing neural network inference from among the plurality of accelerators 410 included in the target device 100. The term ‘optimal accelerator for performing neural network inference’ may refer to an accelerator having a shortest inference time from among a plurality of accelerators when neural network inference is performed by using an accelerator.

The accelerator selector 421 may obtain an inference time of a neural network for each of available accelerators. The accelerator selector 421 may identify accelerators available at a time when neural network inference is performed, from among the plurality of accelerators. For example, when the first accelerator 411 and the second accelerator 412 from among the plurality of accelerators 410 are available, the accelerator selector 421 may obtain an inference time for the first accelerator 411 and an inference time for the second accelerator 412.

The accelerator selector 421 according to an embodiment of the disclosure may obtain an inference time for an accelerator, by selecting arbitrary candidate blocks in a neural network of FIG. 3.

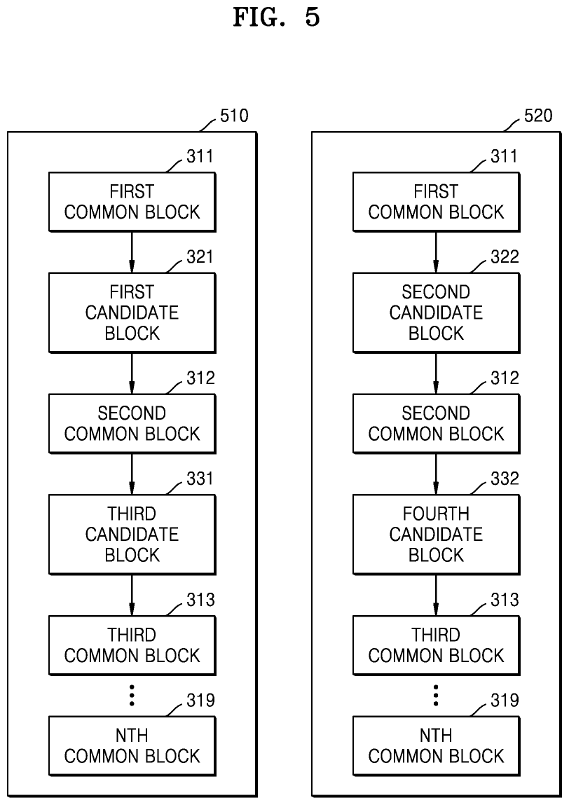

FIG. 5 is a diagram illustrating neural networks configurable according to candidate blocks selected in the neural network of FIG. 3.

For example, as shown in FIG. 5, the accelerator selector 421 may obtain an inference time of each of a neural network, for example a third neural network 510, configured by selecting the first candidate block 321 and the third candidate block 331 and a neural network, for example a fourth neural network 520, configured by selecting the second candidate block 322 and the fourth candidate block 332, in the neural network 300 of FIG. 3.

The accelerator selector 421 may perform inference of the third neural network 510 by using the first accelerator 411, and may obtain an inference time required for the inference. In this case, the accelerator 410 may provide the input data as input to the third neural network 510, and may obtain an inference time of the entire third neural network 510 from which output data is output or may obtain inference times T1 and T3 of the first candidate block 321 and the third candidate block 331.

Also, the accelerator selector 421 may perform inference of the fourth neural network 520 by using the first accelerator 411, and may obtain an inference time of the entire fourth neural network 520 or may obtain inference times T2 and T4 of the second candidate block 322 and the fourth candidate block 332. Also, the accelerator selector 421 may obtain inference times of the third neural network 510 and the fourth neural network 520 for the second accelerator 412.

Also, the accelerator selector 421 may obtain inference times for the first accelerator 411 and the second accelerator 412, based on information of a neural network. The information about the neural network may include information defining a candidate block suitable for an accelerator from among a plurality of candidate blocks, according to a type of the accelerator. In this case, the term ‘candidate block suitable for an accelerator’ may refer to a candidate block having a shortest inference time from among a plurality of candidate blocks included in a selectable block set when neural network inference is performed by using an accelerator. For example, information indicating that a candidate block suitable for a CPU is the first candidate block 321 and the third candidate block 331, and that a candidate block suitable for a GPU is the second candidate block 322 and the fourth candidate block 332 may be included in a neural network model file.

Also, the first accelerator 411 according to an embodiment of the disclosure may be a CPU, and the second accelerator 412 may be a GPU. Accordingly, the accelerator selector 421 may obtain an inference time of the third neural network 510 including the first candidate block 321 and the third candidate block 331 as an inference time for the first accelerator 411, by using the first accelerator 411. In this case, the accelerator selector 421 may not need to obtain an inference time of the fourth neural network 520 by using the first accelerator 411.

Also, the accelerator selector 421 may obtain an inference time of the fourth neural network 520 including the second candidate block 322 and the fourth candidate block 332 as an inference time for the second accelerator 412, by using the second accelerator 412. In this case, the accelerator selector 421 may not need to obtain an inference time of the third neural network 510 by using the second accelerator 412.

In embodiments, the information about the neural network may include an inference time of a candidate block for each accelerator. For example, information about an inference time of each of the first candidate block 321, the second candidate block 322, the third candidate block 331, and the fourth candidate block 332 using a CPU, and an inference time of each of the first candidate block 321, the second candidate block 322, the third candidate block 331, and the fourth candidate block 332 using a GPU may be included in the neural network model file.

When the first accelerator 411 is a CPU and a second accelerator 412 is a GPU, the accelerator selector 421 may select a block having a shorter inference time from among the first candidate block 321 and the second candidate block 322 using the CPU, may select a candidate block having a shorter inference time from among the third candidate block 331 and the fourth candidate block 332, and may obtain an inference time for the first accelerator 411 based on inference tines of the selected candidate blocks.

Also, the accelerator selector 421 may select a candidate block having a shorter inference time from among the first candidate block 321 and the second candidate block 322 using the GPU, may select a candidate block having a shorter inference time from among the third candidate block 331 and the fourth candidate block 332, and may obtain an inference time for the second accelerator 412 based on inference times of the selected candidate blocks.

According to an embodiment of the disclosure, when all of the first through fourth accelerators 411, 412, 413, and 414 are available, the accelerator selector 421 may obtain an inference time of the third accelerator 413 and an inference time for the fourth accelerator 414 by using the same method as the above-described method.

Also, the accelerator selector 421 according to an embodiment of the disclosure may store inference times obtained for the first through fourth accelerators 411, 412, 413, and 414 in a memory. Accordingly, the accelerator selector 421 may not obtain an inference time whenever neural network inference is performed, but may re-use inference times pre-stored in the memory.

The accelerator selector 421 may select one of the plurality of accelerators 410, based on obtained inference times. For example, the accelerator selector 421 may select, but is not limited to, an accelerator having a shortest inference time.

When an accelerator to be used for neural network inference is selected by the accelerator selector 421, the block selector 422 may select a candidate block suitable for the determined accelerator. In this case, the term ‘candidate block suitable for an accelerator’ may refer to a candidate block having a shortest inference time from among a plurality of candidate blocks included in a selectable block set when neural network inference is performed by using an accelerator.

For example, when the first accelerator 411 is determined as an accelerator to be used for neural network inference, the block selector 422 may select candidate blocks suitable for the first accelerator 411, based on an inference time for the first accelerator 411 obtained by the accelerator selector 421. In embodiments, when information about a suitable candidate block according to a type of an accelerator is included in the information about the neural network, the block selector 422 may select candidate blocks suitable for the first accelerator 411 by using the information. However, the disclosure is not limited thereto.

For example, the block selector 422 may select a first candidate block 321 in a first selectable block set and a third candidate block 331 in a second selectable block set, as the candidate blocks suitable for the first accelerator.

When candidate blocks are determined by the block selector 422, the flow controller 423 may control an operation included in the determined candidate blocks to be performed when inference is performed. For example, the flow controller 423 may control a flow of a neural network so that data output from a block prior to a selectable block set included in a neural network is input to a determined candidate block. When the inference engine according to an embodiment of the disclosure does not support a flow control operator, a separate flow controller may be provided. In contrast, when the inference engine 420 supports a flow control operator, a mask tensor for the flow control operator may be used. The mask tensor may be used as a condition for the flow control operator such as an if statement, and the mask tensor may be a binary mask or a natural number-type mask. However, the disclosure is not limited thereto.

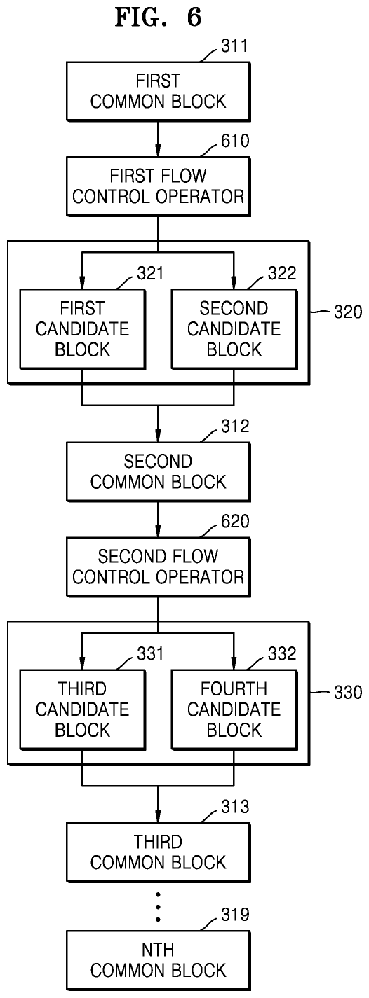

FIG. 6 is a diagram illustrating an example of controlling a flow of a neural network by using a flow control operator, according to an embodiment of the disclosure.

Referring to FIG. 6, a neural network according to an embodiment of the disclosure may include a first flow control operator 610 between the first common block 311 and the first selectable block set 320, and may include a second flow control operator 620 between the second common block 312 and the second selectable block set 330. When the accelerator selector 421 and the block selector 422 respectively determine a first accelerator 411, which may be for example a CPU, as an accelerator suitable for neural network inference and determine the first candidate block 321 and the third candidate block 331 as candidate blocks suitable for the first accelerator 411, the first flow control operator 610 may control a flow of a neural network so that data output from the first common block 311 is input to the first candidate block 321. Also, the second flow control operator 620 may control a flow of a neural network so that data output from the second common block 312 is input to the third candidate block 331. As such, the flow controller 423 according to an embodiment of the disclosure may control a flow of a neural network so that candidate blocks selected by the block selector 422 are used for neural network inference, by using a flow control operator or a separate flow controller.

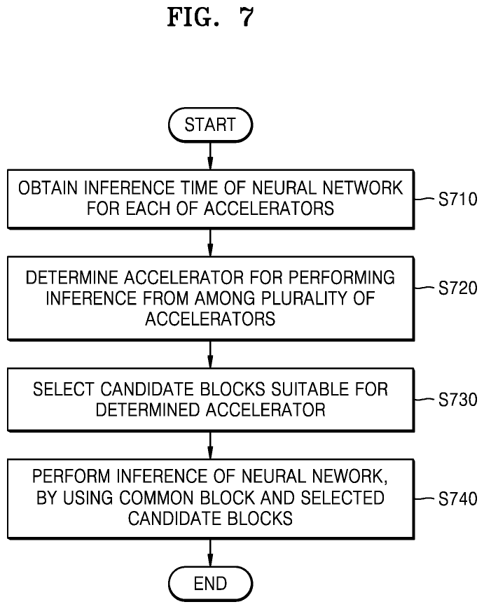

FIG. 7 is a flowchart illustrating an operating method of an electronic device, according to an embodiment of the disclosure.

The electronic device according to an embodiment may be a target device illustrated in and described with reference to FIGS. 1 and 4.

Referring to FIG. 7, the electronic device according to an embodiment of the disclosure may receive information about a trained neural network from an external device, for example a neural network providing apparatus. The information about the trained neural network may be distributed as a data file, for example a neural network model file, including a neural network structure and neural network weights to the electronic device.

When the electronic device receives the neural network model file including the information about the neural network, the electronic device may store the received neural network mode file in a memory. The electronic device may process data, by performing inference of the neural network stored in the memory.

The electronic device according to an embodiment of the disclosure may include a plurality of accelerators, and may perform neural network inference by using one of the plurality of accelerators. In this case, the electronic device may determine an accelerator optimized for neural network inference. The term ‘accelerator optimized for neural network inference’ may refer to an accelerator having a shortest inference time from among a plurality of accelerators, when neural network inference is performed by using an accelerator.

An electronic device according to an embodiment of the disclosure may obtain an inference time of a neural network for each of a plurality of accelerators at operation S710.

For example, the electronic device may identify accelerators available at a time when neural network inference is performed from among the plurality of accelerators, and may obtain an inference time for each of the available accelerators. In this case, when information defining a candidate block suitable for an accelerator or information about an inference time of a candidate block for each accelerator from among a plurality of candidate blocks according to a type of an accelerator is included in information about a neural network, the electronic device may easily obtain an inference time by using the information about the neural network. An example of a detailed method, performed by the electronic device, of obtaining an inference time of a neural network for each accelerator has been described in detail in the description of the accelerator selector 421 of FIG. 4, and thus similar description will be omitted.

The electronic device according to an embodiment of the disclosure may determine an accelerator for performing neural network inference from among the plurality of accelerators, based on the obtained inference time at operation S720. For example, the electronic device may select an accelerator having a shortest inference time, but the disclosure is not limited thereto.

When the accelerator to be used for neural network inference is selected, the electronic device according to an embodiment of the disclosure may select a candidate block suitable for the determined accelerator at operation S730. In this case, the term ‘candidate block suitable for an accelerator’ may refer to a candidate block having a shortest inference time from among a plurality of candidate blocks included in a selectable block set when neural network inference is performed by using an accelerator.

For example, when a first accelerator is determined from among the plurality of accelerators as the accelerator to be used for neural network inference, the electronic device may select candidate blocks (e.g., a first candidate block 321 and a third candidate block 331) suitable for the first accelerator.

The electronic device according to an embodiment of the disclosure may perform inference, by using the candidate blocks selected in operation S730 and common blocks included in the neural network at operation S740.

In this case, the electronic device may control a flow of a neural network so that data output from a block prior to a selectable block set included in the neural network is input to a determined candidate block. The electronic device may control a flow of a neural network so that selected candidate blocks are used for neural network inference, by using a flow control operator supported by an inference engine or a separate flow controller.

As such, when the electronic device according to an embodiment of the disclosure performs data processing requiring repetitive inference using a neural network, for example processing of a video, an audio, or streaming data including a plurality of frame images, the electronic device may selectively use candidate blocks and an accelerator having a short inference time, thereby improving inference efficiency and increasing a data processing speed.

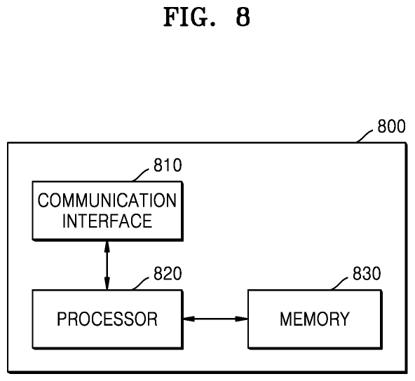

FIG. 8 is a block diagram illustrating a configuration of an electronic device of the disclosure, according to an embodiment.

An electronic device 800 of FIG. 8 may correspond to the target device 100 of FIGS. 1 and 4.

Referring to FIG. 8, the electronic device 800 according to an embodiment of the disclosure may include a communication interface 810, a processor 820, and a memory 830.

The communication interface 810 according to an embodiment of the disclosure may transmit data or a signal to and from an external device or an external server under the control by the processor 820. The communication interface 810 may receive data or a signal by using at least one of wireless local area network (LAN) (e.g., Wi-Fi), Bluetooth, wired Ethernet, Infrared (IR), Bluetooth Low Energy (BLE), Ultrasound, ZigBee, or high-definition multimedia interface (HDMI). The communicator 110 may include at least communication module that may transmit and receive data according to communication standards corresponding to wireless LAN (e.g., Wi-Fi), Bluetooth, wired Ethernet, Infrared (IR), Bluetooth Low Energy (BLE), Ultrasound, ZigBee, and HDMI.

The communication interface 810 according to an embodiment of the disclosure may receive information about a trained neural network including a neural network structure and neural network weights from a neural network providing apparatus.

The processor 820 according to an embodiment of the disclosure controls an overall operation of the electronic device 800 and a flow of a signal between elements of the electronic device 800, and performs a function of processing data. When there is an input of a user or a preset and stored condition is satisfied, the processor 820 may execute an operating system (OS) and various applications stored in the memory 830.

The processor 820 may include a random-access memory (RAM) for storing a signal or data input from the outside of the electronic device 800 or used as a storage corresponding to various tasks performed by the electronic device 800, a read-only memory (ROM) for storing a control program for controlling the electronic device 800, and a processor.

The processor 820 according to an embodiment of the disclosure may execute one or more programs stored in the memory 830. The processor 820 may include a single-core, a dual-core, a triple-core, a quad-core, and a multiple core thereof. Also, the processor 820 may include a plurality of accelerators.

The memory 830 according to an embodiment of the disclosure may store various data, a program, or an application for driving and controlling the electronic device 800. Also, the program stored in the memory 830 may include one or more instructions. The program, for example the one or more instructions, or the application stored in the memory 830 may be executed by the processor 820.

The processor 820 according to an embodiment of the disclosure may perform at least one of operations of the accelerator selector 421, the block selector 422, and the flow controller 423 illustrated in and described with reference to FIG. 4. For example, the processor 820 may obtain an inference time of a neural network for each of the plurality of accelerators, and may determine an accelerator for performing neural network inference from among the plurality of accelerators based on the obtained inference time. Also, when the accelerator to be used for neural network inference is determined, the processor 820 may select candidate blocks suitable for the determined accelerator, and may perform neural network inference by using a neural network including common blocks and the selected candidate blocks.

The memory 830 according to an embodiment of the disclosure may store information about a neural network. The information about the neural network may be a neural network model file including a structure of a trained neural network and neural network weights.

Also, when an inference time is obtained for each of the plurality of accelerators, the memory 830 may store the inference time for each of the plurality of accelerators. Accordingly, the processor 820 may re-use pre-stored inference times.

A block diagram of the target device 100 of FIG. 4 and a block diagram of the electronic device 800 of FIG. 8 are block diagrams for embodiments of the disclosure. Elements of the block diagrams may be combined, added, or omitted according to specifications of the electronic device that is actually implemented. That is, when necessary, two or more components may be combined into one component, or one component may be divided into two or more components. Also, a function performed in each block is for describing embodiments of the disclosure, and a specific operation or device does not limit the scope of the disclosure.

An operating method of an electronic device according to an embodiment of the disclosure may be implemented as program commands executable through various computer means and may be recorded on a computer-readable medium. The computer-readable recording medium may include program commands, data files, data structures, and the like separately or in combinations. The program commands recorded on the computer-readable recording medium may be specially designed and configured for the disclosure or may be well-known to and be usable by one of ordinary skill in the art of computer software. Examples of the computer-readable recording medium include a magnetic medium such as a hard disk, a floppy disk, or a magnetic tape, an optical medium such as a compact disc read-only memory (CD-ROM) or a digital versatile disc (DVD), a magneto-optical medium such as a floptical disk, and a hardware device specially configured to store and execute program commands such as a ROM, a RAM, or a flash memory. Examples of the program commands include advanced language codes that may be executed by a computer by using an interpreter or the like as well as machine language codes that are made by a compiler.

Also, an operating method of an electronic device according to disclosed embodiments of the disclosure may be provided in a computer program product. The computer program product may be a product purchasable between a seller and a purchaser.

The computer program product may include a S/W program, and a computer-readable storage medium in which the S/W program is stored. For example, the computer program product may include a software program-type product (e.g., a downloadable application) electronically distributed through a manufacturer of a broadcast receiver or an electronic market (e.g., Google Play™ store or App Store). For electronic distribution, at least a portion of the software program may be stored in a storage medium or temporarily generated. In this case, the storage medium may be a server of the manufacturer, a server of the electronic market, or a storage medium of a relay server that temporarily stores the software program.

The computer program product may include a storage medium of a server or a storage medium of a client device in a system including the server and the client device. In embodiments, when there is a third device (e.g., a smartphone) communicating with the server or the client device, the computer program product may include a storage medium of the third device. In embodiments, the computer program product may include a software program itself transmitted from the server to the client device or the third device or from the third device to the client device.

In this case, one of the server, the client device, and the third device may execute a method according to disclosed embodiments by executing the computer program product. In embodiments, at least two of the server, the client device, and the third device may execute a method according to disclosed embodiments in a distributed fashion by executing the computer program product.

For example, the server (e.g., a cloud server or an AI server) may execute the computer program product stored in the server, and may control the client device communicating with the server to perform a method according to disclosed embodiments.

Because an electronic device according to an embodiment of the disclosure receives a neural network including a common block and a selectable block set, the electronic device does not need to separately receive a neural network optimized for each accelerator. Accordingly, the efficiency of memory usage may be improved.

Because the electronic device according to an embodiment of the disclosure uses an optimal neural network according to an accelerator to be used for neural network inference, an inference speed may be increased.

Because candidate blocks of the same layer included in a neural network according to an embodiment of the disclosure output similar operation results, the accuracy and performance of inference may be maintained not matter which candidate block is selected from among the candidate blocks. Accordingly, because a candidate block optimized for a determined accelerator is selected, the accuracy and performance of inference may be maintained and an inference time may be reduced.

Although the embodiments have been described in detail above, the scope of the disclosure is not limited thereto, and various modifications and improvements made by one of ordinary skill in the relevant art by using the basic concept of the disclosure defined by the claims are also within the scope of the disclosure.

1. An electronic device for performing inference by using a neural network, the electronic device comprising:
a memory configured to store one or more instructions and information about the neural network, wherein the neural network comprises a common block and a selectable block set; and
a processor comprising a plurality of accelerators, and configured to execute the one or more instructions to:
obtain inference time information about the neural network for each of the plurality of accelerators, based on the information about the neural network;
determine an accelerator for performing the inference according to the neural network from among the plurality of accelerators, based on the inference time information about the neural network;
select a candidate block corresponding to the accelerator from among a plurality of candidate blocks included in the selectable block set; and
perform the inference according to the neural network using the common block and the candidate block.

2. The electronic device of claim 1, wherein the information about the neural network comprises a structure of the neural network and at least one weight of the neural network,
wherein the electronic device further comprises a communication interface configured to receive a neural network model file comprising the information about the neural network from an external device.

3. The electronic device of claim 1, wherein the neural network is trained so that a difference between operation results output using the plurality of candidate blocks included in the selectable block set is less than a preset value.

4. The electronic device of claim 1, wherein the plurality of accelerators includes at least one from among a central processing unit (CPU), a graphics processing unit (GPU), a neural processing unit (NPU), and a digital signal processor (DSP).

5. The electronic device of claim 1, wherein the information about the neural network comprises, information indicating the candidate block corresponding to the accelerator from among the plurality of candidate blocks according to a type of the accelerator,
wherein the processor is further configured to obtain an inference time associated with the neural network using the each of the plurality of accelerators, based on the information indicating the candidate block.

6. The electronic device of claim 1, wherein the inference time information about the neural network comprises inference time information about each of the plurality of candidate blocks, using the each of the plurality of accelerators.

7. The electronic device of claim 1, wherein the processor is further configured to execute the one or more instructions to determine an accelerator having a shortest inference time of the neural network from among the plurality of accelerators as the accelerator.

8. The electronic device of claim 1, wherein the processor is further configured to execute the one or more instructions to store the inference time information about the neural network for the each of the plurality of accelerators in the memory.

9. The electronic device of claim 1, wherein the processor is further configured to execute the one or more instructions to select a candidate block having a shortest inference time corresponding to the accelerator, from among the plurality of candidate blocks included in the selectable block set, as the candidate block.

10. The electronic device of claim 9, wherein the processor is further configured to execute the one or more instructions to control a flow of the neural network, so that output data of a block prior to the candidate block is provided as input to the candidate block.

11. An operating method of an electronic device comprising a plurality of accelerators and capable of performing inference by using a neural network, the operating method comprising:
obtaining inference time information of the neural network for each of the plurality of accelerators, based on information about the neural network, wherein the neural network comprises a common block and a selectable block set;
determining an accelerator for performing the inference according to the neural network from among the plurality of accelerators, based on the inference time information about the neural network;
selecting a candidate block corresponding to the accelerator from among a plurality of candidate blocks included in the selectable block set; and
performing the inference according to the neural network using the common block and the candidate block.

12. The operating method of claim 11, wherein the information about the neural network comprises a structure of the neural network and at least one weight of the neural network, and
wherein the operating method further comprises receiving a neural network model file comprising the information about the neural network from an external device.

13. The operating method of claim 11, wherein the neural network is trained so that a difference between operation results output using the plurality of candidate blocks included in the selectable block set is less than a preset value.

14. The operating method of claim 11, wherein the plurality of accelerators includes at least one from among a central processing unit (CPU), a graphics processing unit (GPU), a neural processing unit (NPU), and a digital signal processor (DSP).

15. A non-transitory computer-readable recording medium having stored thereon instructions which, when executed by at least one processor of a device including a plurality of accelerators and capable of performing inference by using a neural network, cause the at least one processor to:
obtain inference time information of the neural network for each of the plurality of accelerators, based on information about the neural network, wherein the neural network comprises a common block and a selectable block set;
determine an accelerator for performing the inference according to the neural network from among the plurality of accelerators, based on the inference time information about the neural network;
select a candidate block corresponding to the accelerator from among a plurality of candidate blocks included in the selectable block set; and
perform the inference according to the neural network using the common block and the candidate block.
